(19) United States
(12) Patent Application Publication
(10) Pub. No.: US 2026/0197747 A1
(43) Pub. Date: Jul. 9, 2026

(54) WIRELESS COMMUNICATION METHOD, TERMINAL DEVICE, AND NETWORK DEVICE

(71) Applicant: QUECTEL WIRELESS SOLUTIONS CO., LTD., Shanghai (CN)

(72) Inventors: Ling LYU, Frisco, TX (US); Zheng ZHAO, Shanghai (CN)

(21) Appl. No.: 19/552,363

(22) Filed: Feb. 27, 2026

Related U.S. Application Data
(63) Continuation of application No. PCT/CN2024/120273, filed on Sep. 23, 2024.

(51) Int. Cl. H04W 48/14; H04W 48/10; H04W 52/02

(52) U.S. Cl. CPC H04W 48/14; H04W 48/10; H04W 52/0206

(57) ABSTRACT

Disclosed are a wireless communication method, a terminal device, and a network device. One example method includes: receiving, by a terminal device, first information from the network device; and transmitting, by the terminal device to the network device, a first request based on the first information, wherein the first information is used to determine at least one of the following: whether a first cell supports transmission of a target system information block 1 (SIB1), wherein the target SIB1 is triggered based on the first request; a transmission resource of the first request, wherein the first request is used to request the target SIB1 of the first cell; or sequence information of the first request.

### CROSS-REFERENCE TO RELATED APPLICATIONS

This application is a continuation of International Application No. PCT/CN2024/120273, filed on Sep. 23, 2024, the disclosure of which is hereby incorporated by reference in its entirety.

### TECHNICAL FIELD

The present application relates to the field of communications technologies, and more specifically, to a wireless communication method, a terminal device, and a network device.

### BACKGROUND

In a conventional communications system, a network device periodically transmits system information blocks (system information blocks, SIBs) 1. Th-e SIB1 carries not only key information required by the terminal device to access a cell, but also information about availability and scheduling of other SIBs. In some scenarios, in order to save energy in the network, the terminal device may trigger transmission of the SIB1 based on a first request. However, how to transmit the first request is an urgent problem to be solved.

### SUMMARY

The present application provides a wireless communication method, a terminal device, and a network device. Various aspects involved in the present application are described below.

According to a first aspect, a wireless communication method is provided, including receiving, by a terminal device, first information transmitted by a network device, where the first information is used for one or more of the following: determining whether a first cell supports transmission of a target system information block SIB1, where the transmission of the target SIB1 is triggered based on a request of the terminal device; determining a transmission resource of the first request, where the first request is used for requesting the target SIB1 of the first cell; or determining sequence information of the first request.

According to a second aspect, a wireless communication method is provided, including transmitting, by a network device, first information to a terminal device, where the first information is used for one or more of the following: determining whether a first cell supports transmission of a target system information block SIB1, where the transmission of the target SIB1 is triggered based on a request of the terminal device; determining a transmission resource of the first request, where the first request is used for requesting the target SIB1 of the first cell; or determining sequence information of the first request.

According to a third aspect, a terminal device is provided, including a receiving unit, receiving first information transmitted by a network device, where the first information is used for one or more of the following: determining whether a first cell supports transmission of a target system information block SIB1, where the transmission of the target SIB1 is triggered based on a request of the terminal device; determining a transmission resource of the first request, where the first request is used for requesting the target SIB1 of the first cell; or determining sequence information of the first request.

According to a fourth aspect, a network device is provided, including a transmitting unit, transmitting first information to a terminal device, where the first information is used for one or more of the following: determining whether a first cell supports transmission of a target system information block SIB1, where the transmission of the target SIB1 is triggered based on a request of the terminal device; determining a transmission resource of the first request, where the first request is used for requesting the target SIB1 of the first cell; or determining sequence information of the first request.

According to a fifth aspect, a terminal device is provided, including a processor, a memory, and a communications interface. The memory is configured to store one or more computer programs, and the processor is configured to invoke the computer program in the memory, to cause the terminal device to perform a part or all of the steps of the method in the first aspect.

According to a sixth aspect, a network device is provided, including a processor, a memory, and a transceiver. The memory is configured to store one or more computer programs, and the processor is configured to invoke the computer program in the memory, to cause the network device to perform a part or all of the steps in the method in the second aspect.

According to a seventh aspect, an embodiment of the present application provides a communications system. The system includes the foregoing terminal device and/or the foregoing network device. In another possible design, the system may further include another device that interacts with the terminal device or the network device in the solutions provided in embodiments of the present application.

According to an eighth aspect, an embodiment of the present application provides a computer-readable storage medium. The computer-readable storage medium stores a computer program. The computer program causes a communications device (for example, a terminal device or a network device) to perform a part or all of the steps in the method in the foregoing aspects.

According to a ninth aspect, an embodiment of the present application provides a computer program product. The computer program product includes a non-transitory computer-readable storage medium that stores a computer program. The computer program is operable to cause a communications device (for example, a terminal device or a network device) to perform a part or all of the steps in the method in the foregoing aspects. In some implementations, the computer program product may be a software installation package.

According to a tenth aspect, an embodiment of the present application provides a chip. The chip includes a memory and a processor, and the processor may invoke a computer program from the memory and run the computer program, to implement some or all of the steps in the method according to the foregoing aspects.

In the embodiments of the present application, the terminal device receives the first information transmitted by the network device, and the first information is used for determining whether the first cell supports transmission of an on demand SIB1 and/or configuration information related to the first request (for example, the transmission resource of the first request and/or the sequence information of the first request). Compared with a conventional solution in which a SIB1 is transmitted periodically, the terminal device may determine whether it is required to transmit the first request in the first cell to trigger the transmission of the SIB1, and how to transmit the first request in the first cell, which is helpful to reduce unnecessary transmission of SIB1, thereby improving a utilization rate of energy and resources.

### BRIEF DESCRIPTION OF THE DRAWINGS

FIG. 1 shows a wireless communications system 100 to which an embodiment of the present application is applied.

FIG. 2 is a schematic flowchart of a wireless communication method according to an embodiment of the present application.

FIG. 3 is a schematic diagram of a transmitting mode of configuration information according to an embodiment of the present application.

FIG. 4 is a schematic diagram of a related solution of first information according to an embodiment of the present application.

FIG. 5 is a schematic diagram of a terminal device according to an embodiment of the present application.

FIG. 6 is a schematic diagram of a network device according to an embodiment of the present application.

FIG. 7 is a schematic structural diagram of a communications apparatus according to an embodiment of the present application.

### DETAILED DESCRIPTION OF THE EMBODIMENTS

The technical solutions in the present application are described below with reference to the accompanying drawings.

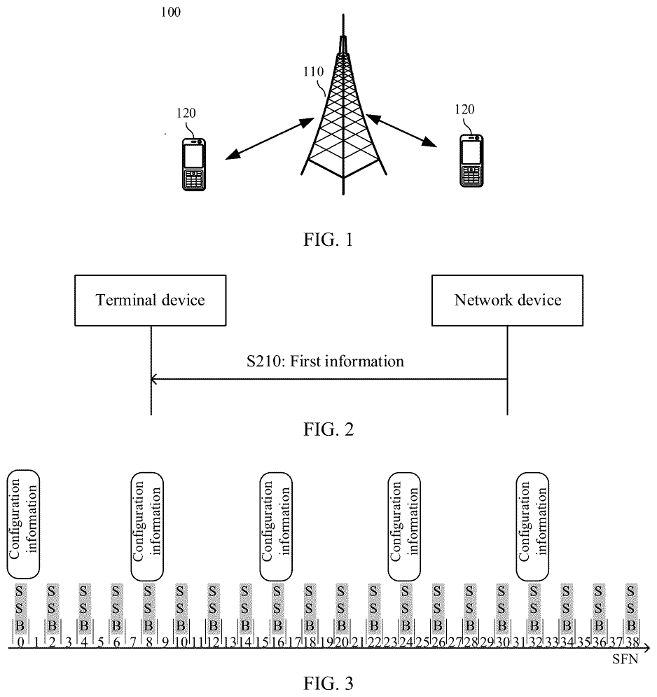

FIG. 1 shows a wireless communications system 100 to which an embodiment of the present application is applied. The wireless communications system 100 may include a network device 110 and terminal devices 120. The network device 110 may be a device that communicates with the terminal device 120. The network device 110 may provide communication coverage for a specific geographic area, and may communicate with the terminal device 120 located within the coverage.

FIG. 1 schematically shows one network device and two terminals. Optionally, the wireless communications system 100 may include a plurality of network devices, and another quantity of terminal devices may be included within coverage of each network device. This is not limited in embodiments of the present application.

Optionally, the wireless communications system 100 may further include other network entities such as a network controller and a mobility management entity. This is not limited in embodiments of the present application.

It should be understood that the technical solutions of embodiments of the present application may be applied to various communications systems, such as a 5th generation (5th generation, 5G) system or a new radio (new radio, NR) system, a long-term evolution (long term evolution, LTE) system, an LTE frequency division duplexing (frequency division duplex, FDD) system, and an LTE time division duplexing (time division duplex, TDD) system. The technical solutions provided in the present application may further be applied to a future communications system, such as a 6th generation mobile communications system or a satellite communications system.

The terminal device in embodiments of the present application may also be referred to as user equipment (user equipment, UE), an access terminal, a subscriber unit, a subscriber station, a mobile site, a mobile station (mobile station, MS), a mobile terminal (mobile terminal, MT), a remote station, a remote terminal, a mobile device, a user terminal, a terminal, a wireless communications device, a user agent, or a user apparatus. The terminal device in embodiments of the present application may be a device providing a user with voice and/or data connectivity and capable of connecting people, objects, and machines, such as a handheld device or a vehicle-mounted device having a wireless connection function. The terminal device in embodiments of the present application may be a mobile phone (mobile phone), a tablet computer (Pad), a notebook computer, a palmtop computer, a mobile Internet device (mobile internet device, MID), a wearable device, a virtual reality (virtual reality, VR) device, an augmented reality (augmented reality, AR) device, a wireless terminal in industrial control (industrial control), a wireless terminal in self driving (self driving), a wireless terminal in remote medical surgery (remote medical surgery), a wireless terminal in a smart grid (smart grid), a wireless terminal in transportation safety (transportation safety), a wireless terminal in a smart city (smart city), a wireless terminal in a smart home (smart home), or the like. Optionally, the UE may be configured to function as a base station. For example, the UE may function as a scheduling entity, which provides a sidelink signal between UEs in V2X, D2D, or the like. For example, a cellular phone and a vehicle communicate with each other by using a sidelink signal. A cellular phone and a smart home device communicate with each other, without relay of a communication signal through a base station.

A network device in embodiments of the present application may be a device for communicating with the terminal device. The network device may also be referred to as an access network device or a radio access network device. For example, the network device may be a base station. The network device in embodiments of the present application may be a radio access network (radio access network, RAN) node (or device) that connects the terminal device to a wireless network. The base station may broadly cover the following various names, or may be interchanged with the following names, such as a NodeB, an evolved NodeB (evolved NodeB, eNB), a next generation NodeB (next generation NodeB, gNB), a relay station, an access point, a transmitting and receiving point (transmitting and receiving point, TRP), a transmitting point (transmitting point, TP), a master eNode MeNB, a secondary eNode SeNB, a multi-standard radio (MSR) node, a home base station, a network controller, an access node, a radio node, an access point (access point, AP), a transmission node, a transceiver node, a baseband unit (baseband unit, BBU), a remote radio unit (remote radio unit, RRU), an active antenna unit (active antenna unit, AAU), a remote radio head (remote radio head, RRH), a central unit (central unit, CU), a distributed unit (distributed unit, DU), and a positioning node. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in device-to-device D2D, vehicle-to-everything (vehicle-to-everything, V2X), and machine-to-machine (machine-to-machine, M2M) communications, a network-side device in a 6G network, a device that functions as a base station in a future communications system, or the like. The base station may support networks of a same access technology or different access technologies. A specific technology and a specific device used by the network device are not limited in embodiments of the present application.

The base station may be a fixed or mobile base station. For example, a helicopter or an unmanned aerial vehicle may be configured to function as a mobile base station, and one or more cells may move according to a location of the mobile base station. In other examples, a helicopter or an unmanned aerial vehicle may be configured to function as a device in communication with another base station.

In some deployments, the network device in embodiments of the present application may be a CU or a DU, or the network device includes a CU and a DU. The gNB may further include an AAU.

The network device and the terminal device may be deployed on land, including being indoors or outdoors, handheld, or vehicle-mounted, may be deployed on a water surface, or may be deployed on a plane, a balloon, or a satellite in the air. In embodiments of the present application, a scenario of the network device and the terminal device is not limited.

It should be understood that all or some of functions of the communications device in the present application may also be implemented by software functions running on hardware, or by virtualization functions instantiated on a platform (for example, a cloud platform).

With development of mobile communications technologies, a communications system adopts a large-scale multiple-input multiple-output (multiple-input multiple-output, MIMO) technology, technologies such as a non-orthogonal multiple access technology, a simultaneous intra-frequency full-duplex communications technology, an advanced modulation technology, an advanced coding technology, and a high-order modulation technology can implement a standard in which a peak rate reaches Gbit/s, so as to meet large-scale data transmission such as high-definition video and virtual reality. An air interface delay level needs to be around 1 ms to meet real-time applications such as self-driving and telemedicine. An ultra-large network capacity provides connection capability of hundreds of billions of devices and satisfies Internet of Things communication. Spectrum efficiency is more than 10 times higher than that of a previous communications system. Under continuous wide-area coverage and high mobility, a user experience rate reaches 100 Mbit/s. A traffic density and a connection density are greatly increased. Collaborative and intelligent levels of the system are improved, which is characterized by multi-user, multi-point, multi-antenna, multi-intake collaborative networking and flexible and automatic adjustment between networks.

A system message of a communications system may be divided into a master information block (master information block, MIB) message and some system information blocks (system information blocks, SIB) messages. The MIB message is always transmitted on a broadcast channel (broadcast channel, BCH) with a period of 80 ms, and is repeatedly transmitted in the 80 ms. The MIB message further includes parameters required for acquiring a SIB1 message from a cell. The SIB1 includes information about availability and scheduling of another SIB which is periodically broadcast or provided as required. In a case that another SIB is provided as required, the SIB1 includes information for the terminal device to perform a system information (system information, SI) request. SIBs other than the SIB1 are included in SI messages, which are transmitted on a downlink shared channel (downlink shared channel, DL-SCH). Each SI message is periodically transmitted in a time domain window (referred to as an SI window); and the SIB1 is transmitted on the DL-SCH with a period of 160 ms and a variable transmission repetition period within 160 ms. A default transmission repetition period of the SIB1 is 20 ms, but an actual transmission repetition period depends on network implementation. The SIB1 may carry key information required by the terminal device to access a cell, for example, a random access parameter. The SIB1 includes information about availability and scheduling of another SIB. For example, the SIB1 includes mapping of another SIB to an SI message, a period, an SI window size, and the like. The SIB1 may further indicate whether one or more SIBs are provided only on demand. In this case, the SIB1 may further provide a physical random access channel (physical random access channel, PRACH) configuration required by the terminal device, so as to request a required SI message. The SIB1 further includes radio resource configuration information common to all terminal devices and cell barring information applied to unified access control. The SIBs other than the SIB1 are carried in the SI message, and the message is transmitted on the DL-SCH. Only SIBs with a same period can be mapped to a same SI message. Each SI message is transmitted within a time domain window that occurs periodically (All SI messages may have SI windows of a same length). Each SI message is associated with an SI window, and SI windows of different SI messages do not overlap. That is, only a corresponding SI message is transmitted in one SI window. The SI message may be transmitted in the SI window multiple times.

As described above, in the conventional communications system, the network device periodically transmits the SIB1, while it cannot be ensured that each transmitted SIB1 is effectively used by the terminal device, which may cause a waste of resources.

For example, an access network device in a communications system periodically sends the SIB1 for initial access of a terminal device, and schedules another SIB required by a terminal device in an idle/inactive mode. However, even if there is no need from the terminal device, or no terminal device (for example, UE) camps on a cell, the access network device always performs SIB1 transmission.

This solution of periodically transmitting the SIB1 may cause relatively high energy consumption of the access network device (for example, a base station), thereby causing a waste of energy. In addition, not all transmitted SIB1 can be effectively used, resulting in a waste of transmission resources.

For the foregoing problem, in order to save energy consumption of the access network device, the SIB1 needs to be optimized. In some known solutions, the terminal device may trigger transmission of the SIB1 based on a request (hereinafter also referred to as a “first request”), that is, the terminal device may trigger transmission of the SIB1 based on the first request according to a requirement of the terminal device. For example, in a case that a terminal device in the idle/inactive mode needs the SIB1, the terminal device may transmit the first request to a network device to trigger transmission of the SIB1; and in a case that a terminal device in the idle/inactive mode does not need the SIB1, the terminal device may not transmit the first request to a network device. In some scenarios, this transmission manner of the SIB1 may also be referred to as on demand (on demand) transmission of the SIB1. Compared with a conventional solution in which the SIB1 is periodically transmitted, this solution in which the SIB1 is transmitted on demand is beneficial for reducing unnecessary SIB1 transmission and associated PRACH monitoring, thus providing more opportunities for the network device to be in a sleep mode. However, how to transmit the first request is an urgent problem to be solved.

In order to solve the above problems, an embodiment of the present application provides a wireless communication method. A terminal device receives first information transmitted by a network device, where the first information is used to determine whether a first cell supports transmission of an on demand SIB1 and/or transmission of configuration information related to the first request (for example, a transmission resource of the first request and/or sequence information of the first request). Compared with a conventional solution in which the SIB1 is transmitted periodically, the terminal device may determine whether it is required to transmit the first request in the first cell to trigger the transmission of the SIB1, and how to transmit the first request in the first cell, which is helpful to reduce unnecessary SIB1 transmission and improve a utilization rate of energy and resources.

The following describes the wireless communication method according to this embodiment of the present application with reference to FIG. 2. FIG. 2 is a schematic flowchart of a wireless communication method according to an embodiment of the present application. The method shown in FIG. 2 includes Step S210.

Step S210: A network device transmits first information to a terminal device.

In some implementations, the first information is used to determine whether a first cell supports transmission of a target SIB1, where the transmission of the target SIB1 is triggered based on a request of the terminal device. The transmission of the target SIB1 is triggered by the request of the terminal device, so the target SIB1, namely the on demand SIB1 above, may also be referred to as “OD-SIB1 (on demand SIB1)”.

Since the transmission of the target SIB1 is beneficial for improving a utilization rate of energy and resources, in some implementations, in a case that the first cell supports the transmission of the target SIB1, the first cell may also be referred to as a network energy saving (network energy saving, NES) cell, that is, the target SIB1 comes from a NES cell.

In some implementations, a terminal device that supports triggering the SIB1 based on a request of the terminal device is also referred to as a terminal device with a NES capability.

In some implementations, a terminal device that does not support triggering the SIB1 based on a request of the terminal device is also referred to as a terminal device without a NES capability or a conventional terminal device.

In some implementations, the first information is used to determine whether the first cell supports the transmission of the target SIB1, which may be understood as that the first information is used to determine whether the first cell is a NES cell.

In some other implementations, the first information is used to determine the transmission resource of the first request, and/or the sequence information of the first request.

In some implementations, the first request is used to request the target SIB1 of the first cell, or the first request is used to request the network device of the first cell to transmit the target SIB1, or the target SIB1 of the first cell is triggered based on the first request. For example, a synchronization signal block/physical broadcast channel block (synchronization signal block/physical broadcast channel block, SS/PBCH block, SSB) transmitted by the first cell does not carry the SIB1, and the terminal device in the idle/inactive mode may transmit the first request to the first cell, to request the first cell to transmit the target SIB1, so as to access the first cell.

In the embodiment of the present application, the first request is not limited. For example, the first request may be an uplink wake up signal (uplink wake up signal, UL WUS), which is used to wake up a network device in an uplink, so that the network device can transmit the target SIB1 at an appropriate time. As another example, the first request may be “on demand information or signaling”.

In the embodiment of the present application, the transmission resource is not limited. In some implementations, the transmission resource may include one or more of the following: a time-domain resource, a frequency-domain resource, or a code-domain resource. For example, the transmission resource includes a time-domain resource, where the time-domain resource may include a symbol, a slot, a subframe, a frame, and the like. Certainly, in embodiments of the present application, the transmission resource may further include another time-domain resource introduced in a future communications system. For example, the transmission resource includes a frequency-domain resource, where the frequency-domain resource may include a subcarrier, a frequency band, a bandwidth, and the like. Certainly, in embodiments of the present application, the frequency-domain resource may further include another frequency-domain resource introduced in a future communications system. For example, the transmission resource includes a code-domain resource, where the code-domain resource may include a codebook, a codeword, and the like. Certainly, in embodiments of the present application, the code-domain resource may further include another code-domain resource introduced in a future communications system.

Hereinafter, the related solution of the first information in the embodiment of the present application will be introduced in combination with Embodiment 1 and Embodiment 2.

### Embodiment 1: First Information is Used to Determine Whether a First Cell Supports Transmission of a Target SIB1

In some implementations, in a case that the first information is used to determine whether the first cell supports the transmission of the target SIB1, the first information includes a first parameter and/or configuration information.

In some implementations, the first parameter is carried in a field of a physical broadcast channel (physical broadcast channel, PBCH) of the first cell. In other words, the first parameter is carried in a PBCH payload of the first cell. For example, a terminal device can acquire the first parameter from the PBCH payload, and the first parameter is used to indicate identity information of the first cell (for example, information used to determine whether the first cell supports the transmission of the target SIB1). Both a terminal device with a NES capability and a terminal device without a NES capability can detect a SSB of the first cell and acquire the PBCH, and then acquire the first parameter.

In some implementations, the first parameter is carried in a MIB of the first cell. In other words, the first parameter is carried in the MIB of the first cell.

In some implementations, the first parameter is carried in a spare bit of the MIB of the first cell. For example, the first parameter may be carried in spare bits of the MIB that are not used by another function, and these spare bits may be redefined or expanded to indicate whether the first cell supports the transmission of the target SIB1. With this method, it is convenient for each terminal device receiving the SSB of the first cell to determine whether the first cell is a NES cell, which may provide the terminal device with a capability of rapid identification and is beneficial to reducing signalling overhead.

In some implementations, the first parameter is carried in an existing field of the MIB of the first cell. For example, the first parameter is carried in a parameter SSB-SubcarrierOffset of the MIB of the first cell.

In some implementations, in a case that the first parameter is carried in the existing field of the MIB of the first cell, the first parameter may be used to indicate a frequency domain offset between a transmission resource of the SSB and a reference resource. For example, the first parameter is Kssb, the reference resource is

$${N}_{CRB}^{SSB} ,$$

the Kssb is used to determine a frequency domain offset between the transmission resource of the SSB and

$${N}_{CRB}^{SSB} ,$$

and the Kssb is carried in the parameter SSB-SubcarrierOffset of the MIB of the first cell. Certainly, in embodiments of the present application, the first parameter may also be used to indicate other information.

In some implementations, the first information includes only the first parameter, and the first parameter may be used to determine whether the first cell supports the transmission of the target SIB1. For example, the first parameter is Kssb, and the Kssb is a part for identifying the SSB, and may be used to indicate whether the first cell supports the transmission of the target SIB1. In this way, the terminal device may determine, without receiving the SIB1, whether the first cell supports the transmission of the target SIB1.

In some implementations, a value of the first parameter may be one or more predefined or preconfigured values. For example, when the first parameter is Kssb, and a value of the Kssb included in the first information is defined based on a protocol as one or more values in invalid values, it indicates that the first cell supports the transmission of the target SIB1.

In some implementations, the first parameter is Kssb, and a value of the first parameter may be a reserved value of Kssb. For example, frequency ranges (frequency range, FR) 1 and FR2 each have a reserved value of Kssb, which is not used for normal SSB transmission, but is specifically used to indicate whether the first cell supports the transmission of the target SIB1. Therefore, the reserved value of the Kssb may be used to indicate that the first cell is a NES cell supporting the transmission of the target SIB1. For another example, as for the FR1, when the value of the Kssb is 30, it indicates that the first cell supports the transmission of the target SIB1. As for the FR2, when the value of the Kssb is 14, it indicates that the first cell supports the transmission of the target SIB1.

In some implementations, the first parameter is Kssb, and the value of the first parameter may be a valid value of the Kssb. For example, the valid value of the Kssb of the FR1 ranges from 0 to 23, and the valid value of the Kssb of the FR2 ranges from 0 to 11. In a conventional solution, the terminal device may determine, from the MIB according to the valid value of the Kssb, whether a control resource set (control resource set, CORESET) that is used for a type 0 (Type 0) physical downlink control channel (physical downlink control channel, PDCCH) common search space (common search space, CSS) set exists. In embodiments of the present application, an existing valid value of Kssb may be reinterpreted to indicate whether the first cell supports the transmission of the target SIB1. For another example, for the FR1, in a case that a protocol defines that the value of the Kssb is one or more values in the range of 0 to 23, such as 12 and 18, it may indicate that the first cell supports the transmission of the target SIB1. For the FR2, in a case that the protocol defines that the value of the Kssb is one or more values in the range of 0 to 11, such as 3 and 5, it may indicate that the first cell supports the transmission of the target SIB1.

In some implementations, the first parameter is Kssb, and the value of the first parameter may be an invalid value of the Kssb. For example, the invalid value of the Kssb of the FR1 ranges from 24 to 31, the invalid value of the Kssb of the FR2 ranges from 12 to 15, and the invalid value of the Kssb is not used, which may be used to indicate whether the first cell supports the transmission of the target SIB1. For another example, for the FR1, in a case that a protocol defines that the value of the Kssb is one or more values in the range of 24 to 31, such as 25 and 28, it may indicate that the first cell supports the transmission of the target SIB1. For the FR2, in a case that the protocol defines that the value of the Kssb is one or more values in the range of 12 to 15, such as 13 and 14, it may indicate that the first cell supports the transmission of the target SIB1.

In some implementations, the configuration information above is used to configure a first request. For example, the first request is UL WUS, the configuration information is UL WUS configuration information, and the configuration information is used to configure the UL WUS.

In some implementations, the configuration information is associated with one or more first cells. In other words, first requests corresponding to one or more first cells may be configured based on the configuration information.

In embodiments of the present application, a manner in which the terminal device receives the configuration information is not limited in embodiments of the present application. In some implementations, the configuration information is received by the terminal device in an anchor cell. For example, the configuration information is associated with one or more first cells, one anchor cell may manage one or more first cells, and the anchor cell may have the same DU as that of one or more first cells. One anchor cell may transmit the configuration information to terminal devices camping or accessed in one or more first cells associated with the configuration information. This configuration information requires coordination of the anchor cell in one or more first cells to ensure effective transmission and reception of signals. Since changes in the SIB1 may occur periodically, synchronization between one or more first cells and anchor cells is required, and a fallback procedure may be developed to ensure rapid and reliable recovery from a failure. In this case, the configuration information received by the terminal device camping on or accessed the first cell includes configuration information corresponding to the first cell on which the terminal device camps and/or configuration information corresponding to another first cell. In some other implementations, the configuration information is received by the terminal device in the first cell. For example, the configuration information is associated with one first cell, and the configuration information is relatively simple. However, signal transmission and resource allocation in the first cell still need to be considered. When the terminal device camps on or is connected to the first cell associated with the configuration information, the terminal device may receive the configuration information. In this case, the configuration information received by the terminal device includes only configuration information corresponding to the first cell on which the terminal device camps or to which the terminal device is connected.

In some implementations, in a case that the configuration information is received by the terminal device in the first cell, and the existence of the configuration information is an implicit indication that the target SIB1 may be requested in the first cell. That is, in a case the terminal device receives the configuration information in the first cell, it may be determined that the first cell supports the transmission of the target SIB1.

In some implementations, the configuration information is associated with one or more first cells, and it may be understood that the configuration information is associated with a physical cell identifier (physical cell identifier, PCI) of one or more first cells and/or frequency information of one or more first cells, that is, based on the PCI of the first cell and/or the frequency information of one or more first cells, it may be determined whether the first cell supports the transmission of the target SIB1. For example, the PCI of one or more first cells associated with the configuration information may be acquired by detecting a SSB of a cell A when a terminal device with a NES capability camps in the cell A. In a case that the PCI of the cell A is associated with the configuration information, the terminal device may determine that the cell A supports the transmission of the target SIB1.

In some implementations, a transmitting mode of the configuration information includes one or more of the following: being periodically broadcast; being carried in downlink control information (downlink control information, DCI); being carried in a physical downlink shared channel (physical downlink shared channel, PDSCH); and being carried in a SIB.

In some implementations, the transmitting mode of the configuration information includes being periodically broadcast. It may be understood that, the anchor cell may be used as a master cell, and is responsible for uniformly and periodically broadcasting configuration information associated with one or more first cells. Correspondingly, a terminal device that camps on or accesses one or more first cells may receive the configuration information that is periodically broadcast.

In some implementations, to save energy to a maximum extent, a broadcast period of the configuration information may be a long period, that is, greater than 20 ms. This long-period configuration information broadcast manner is also referred to as a “sparse mode”. For example, referring to FIG. 3, the SSB is broadcast once every 20 ms, the configuration information is broadcast once every 80 ms, and the network device of the anchor cell broadcasts the configuration information in SFN0, SFN8, SFN16, SFN24, and SFN32 in system frame number (system frame number, SFN) 0 to 38.

In some implementations, the transmitting mode of the configuration information includes being carried in the DCI. It may be understood that, the configuration information is carried in a new DCI format. For example, a maximum interleaver input is 164 bits, 24 bits are reserved for a cyclic redundancy check (cyclic redundancy check, CRC). Therefore, a payload size of the DCI is limited to 140 bits, and the configuration information is carried by using a new DCI format with a payload size of 140 bits.

In some implementations, the transmitting mode of the configuration information includes being carried in the DCI. It may be understood that, the configuration information is carried in an existing DCI format. For example, a CORESET that carries a PDCCH with the configuration information is carried by using a remaining reserved bit on DCI_1_0, and the CORESET may be easily multiplexed in a same timeslot that carries the SSB.

In some implementations, the transmitting mode of the configuration information includes being carried in the PDCCH. It may be understood that in a case that more than 140 bits of data is required to be transmitted in the configuration information, the PDSCH may be used to carry the configuration information.

In some implementations, the transmitting mode of the configuration information may include being carried in the SIB. That is, the configuration information is carried in the SIB.

In some implementations, the configuration information is carried in the SIB. It may be understood that, the configuration information is carried in an existing SIB of the anchor cell. For example, the configuration information is carried in the SIB of the anchor cell (for example, SIB1, SIB2, and the like).

In some implementations, the configuration information is carried in the SIB. It may be understood that, the configuration information is carried in a newly added SIB of the anchor cell.

In some implementations, the transmitting mode of the configuration information may include being carried in another broadcast information of the anchor cell. For example, the configuration information is carried in the SSB of the anchor cell.

In some implementations, the configuration information may be frequency-division multiplexed with the SSB. For example, referring to FIG. 3, the SSB is broadcast once every 20 ms, the configuration information is broadcast once every 80 ms, and the configuration information is frequency-division multiplexed with the SSB in SFN0, SFN8, SFN16, SFN24, and SFN32 in SFN0 to SFN0 38. For another example, the configuration information is carried in a PDSCH. It is assumed that a bandwidth of an initial bandwidth part (bandwidth part, BWP) includes 48 resource blocks (resource block, RB), and the SSB occupies 20 RBs, for synchronizing signals and broadcast messages. These 20 RBs are not used by CORESET #0 or the PDSCH. Frequency-domain multiplexing may be carried out on the CORESET #0 on the remaining 28 RBs and CORESET #0 coexists with the SSB. These 28 RBs may be used for transmission of a control channel (for example, PDCCH) and transmission of data (for example, PDSCH) of the CORESET #0. In this multiplexing mode, although the SSB occupies 20 RBs and these RBs cannot be scheduled by the PDSCH, the CORESET #0 and the PDSCH carrying the configuration information can still perform frequency-domain multiplexing by using the remaining 28 RBs in the initial BWP. This allocation mode ensures that resources of the SSB are not interfered with by other signals, and still provides sufficient resources for the PDSCH to transmit the configuration information.

In some other implementations, the terminal device receives the configuration information, and the configuration information may be stored in a memory of the terminal device, so that the terminal device uses the configuration information at a time when the configuration information is not transmitted.

In some other implementations, the network device sends first indication information to the terminal device, where the first indication information is used to indicate update of the configuration information. For example, the first cell is a NES cell, and the first indication information is SI update indication. When the terminal device camps on the NES cell, the SI update indication may be acquired from the NES cell, or may be acquired from the anchor cell, and the SI update indication may indicate an updated version with the configuration information.

In some implementations, before the terminal device sends the first request, in a case that the terminal device receives the first indication information transmitted by the network device, the terminal device acquires the updated configuration information, and stores the updated configuration information in the memory of the terminal device. For example, the first cell is a NES cell, and the terminal device camps on the first cell. Before transmitting the first request, the terminal device receives the first indication information from the first cell, and may acquire the updated configuration information from the first cell, and store the updated configuration information in the memory of the terminal device. The configuration information is associated with only the first cell on which the terminal device camps, and the terminal device may transmit the first request in the first cell based on the updated configuration information. For another example, the first cell is a NES cell, and the terminal device camps on the first cell. Before transmitting the first request, the terminal device receives the first indication information from the anchor cell, where the first indication information indicates update of the configuration information corresponding to the first cell. After receiving the first indication information, the terminal device may acquire the updated configuration information from the anchor cell. The terminal device stores the updated configuration information in the memory of the terminal device. The configuration information is associated with the first cell and multiple other NES cells. The terminal device may transmit the first request based on the updated configuration information corresponding to the first cell on which the terminal device camps, for acquiring the SIB1 to re-camp on the first cell or initially access a new NES cell.

In some implementations, the updated configuration information may be acquired by using an SI and/or a radio resource control (radio resource control, RRC) message. For example, the first cell is a NES cell, and the first cell releases the updated configuration information by using the SI and/or the RRC message.

In conventional solutions, the SIB1 may have two transmission modes in the first cell: periodic SIB1 or SIB1-less (SIB1-less), which may be identified by a cell defining SSB (cell defining SSB, CD-SSB) or a non-cell defining SSB (non-cell defining SSB, NCD-SSB). The CD-SSB is a SSB associated with remaining minimum system information (remaining minimum system information, RMSI) (for example SIB1), a PBCH payload parameter Kssb of the CD-SSB is set to have a value less than 24 in a FR1, and a value less than 12 in a FR2. For the non-cell defining SSB (NCD-SSB), the value of the Kssb in the FR1 is set to be greater than or equal to 24, and the value of the Kssb in the FR2 is set to be greater than or equal to 12. In a case that the first cell has a CD-SSB (in other words, the value of the Kssb in the FR1 is less than 24, and the value of the Kssb in the FR2 is less than 12), the first cell has a periodic SIB1. For the CD-SSB, a MIB parameter “pdcch-ConfigSIB1” of the CD-SSB denotes configuration of pdcch CoreSetZero and SearchSpaceZero for transmission of the periodic SIB1. In addition to having the CD-SSB, the first cell with the periodic SIB1 may have no NCD-SSBs or have one or more NCD-SSBs.

In some implementations, in a case that the first cell supports the transmission of the target SIB1, the first cell may have three SIB1 transmission modes: periodic SIB1, SIB1-less, or OD-SIB1.

A conventional terminal device can identify only the periodic SIB1 and the SIB1-less. To avoid a negative impact on the conventional terminal device (for example, accessing a first cell), in some implementations, in a case that the first cell supports the transmission of the target SIB1, the SSB in the first cell is a non-cell defining SSB; alternatively, for the first cell that supports the transmission of the target SIB1, a SSB of the first cell that is always online may be set as a NCD-SSB, that is, the value of the Kssb in the FR1 is greater than or equal to 24, and the value of the Kssb in the FR2 is greater than or equal to 12; alternatively, for the first cell that supports the transmission of the target SIB1, in a case that the first cell has one or more SSBs, all SSBs should be NCD-SSBs.

In some implementations, in a case that the terminal device does not support triggering the SIB1 based on the request of the terminal device and the first cell supports the transmission of the target SIB1, the terminal device identifies the OD-SIB1 as the SIB1-less, so as to avoid being unable to access the first cell. In other words, in a case that the first cell supports the transmission of the OD-SIB1, the conventional terminal device determines not to transmit the SIB1 in the first cell when the conventional terminal device receives the NCD-SSB in the first cell.

In some implementations, in a case that the terminal device does not support triggering the SIB1 based on the request of the terminal device, the terminal device receives second information transmitted by the network device, where the second information is used to determine a search space of the cell-defining SSB transmitted in the first cell. Correspondingly, the terminal device that does not support triggering the SIB1 based on the request of the terminal device may search, based on the second information, for the cell defining SSB transmitted in the first cell, and further receive the SIB1 based on the search space of the SIB1 carried in the cell defining SSB, so as to access the first cell.

In some implementations, the second information is carried in the MIB of the non-cell defining SSB. For example, the second information is carried in parameters pdcch-ConfigSIB1 and kssb of the MIB of the non-cell defining SSB transmitted in the first cell, and the reserved values of the pdcch-ConfigSIB1 and the kssb together indicate auxiliary information of the terminal device for searching for the CD-SSB.

However, for the terminal device that supports triggering the SIB1 based on the request of the terminal device, a cell that transmits only the NCD-SSB may be a cell that supports transmitting the OD-SIB1, or may be a cell that supports transmitting the SIB1-less. To further distinguish the two modes, in some implementations, in a case that the terminal device supports triggering the SIB1 based on the request of the terminal device, and the SSB of the first cell received by the terminal device is a non-cell defining SSB, the terminal device determines, based on the first parameter and/or the configuration information, whether the first cell supports the transmission of the target SIB1.

In some implementations, in a case that the terminal device supports triggering the SIB1 based on the request of the terminal device, and the SSB of the first cell received by the terminal device is a non-cell defining SSB, the terminal device determines, based on the first parameter, whether the first cell supports the transmission of the target SIB1. For example, the first parameter is the Kssb of the non-cell defining SSB, and the reserved value of the Kssb (for example, the value of the Kssb in the FR1 is 30, and the value of the Kssb in the FR2 is 14) indicates that the first cell supports the transmission of the target SIB1. In this case, the MIB parameter “pdcch-ConfigSIB1” of the non-cell defining SSB may also be reserved and does not provide auxiliary information for the conventional device to search for the CD-SSB. For another example, the value of Kssb may also be in a range of NCD-SSB, that is, the value of the Kssb in the FR1 is set to be greater than or equal to 24, and the value of the Kssb in the FR2 is set to be greater than or equal to 12.

In some implementations, in a case that the terminal device supports triggering the SIB1 based on the request of the terminal device, and the SSB of the first cell received by the terminal device is a non-cell defining SSB, the terminal device determines, based on the configuration information, whether the first cell supports the transmission of the target SIB1. For example, in a case that all SSBs transmitted in the first cell are NCD-SSBs, and the first cell is associated with the configuration information, the first cell supports the transmission of the target SIB1, that is, the first cell supports the transmission of the OD-SIB1. Otherwise, the first cell does not support the transmission of the target SIB1, but supports the transmission of the SIB1-less.

In some implementations, the terminal device that supports triggering the SIB1 based on the request of the terminal device determines, based on the configuration information, whether the first cell supports the transmission of the target SIB1. For example, in a case that the configuration information is associated with the PCI of the first cell and/or the frequency information of the first cell, it may be determined that the first cell supports the transmission of the target SIB1. Otherwise, the first cell does not support the transmission of the target SIB1.

In some implementations, the terminal device that supports triggering the SIB1 based on the request of the terminal device determines, based on the first parameter and the configuration information, whether the first cell supports the transmission of the target SIB1. For example, the first parameter is Kssb, the value of the Kssb of the SSB transmitted in the first cell is set to be greater than or equal to 24 in the FR1, the value of the Kssb in the FR2 is set to be greater than or equal to 12, and the terminal device having the NES capability determines, based on the first parameter, that all SSBs transmitted in the first cell are NCD-SSBs. The configuration information received by the terminal device is associated with the PCI of the first cell, and the terminal device may determine, based on the PCI of the first cell, that the first cell supports the transmission of the target SIB1.

### Embodiment 2: First Information is Used to Determine a Transmission Resource of a First Request and/or Sequence Information of the First Request

In some implementations, in a case that the first information is used to determine the transmission resource of the first request and/or the sequence information of the first request, the first information includes configuration information used to configure the first request.

It should be noted that the description of the configuration information in Embodiment 1 is also applicable to Embodiment 2, and details are not described herein again. Certainly, description of configuration sub-information in Embodiment 2 is also applicable to Embodiment 1.

In some implementations, the configuration information is associated with one or more first cells, and configuration information corresponding to a first cell is determined based on one or more of the following: a transmission resource of the configuration information corresponding to the first cell; and sequence information of the configuration information corresponding to the first cell.

In some implementations, the configuration information of the first cell is determined based on the configuration information corresponding to the first cell. For example, the configuration information is associated with multiple first cells, the first cell is a NES cell, different sequences may be allocated to configuration information corresponding to different first cells, and the configuration information corresponding to different first cells may be determined based on the sequence information, so as to avoid confusion and interference. For another example, a unique sequence (such as a Zadoff-Chu sequence or a Gold sequence) is assigned to each first cell as a sequence of the configuration information corresponding to each first cell. The configuration information is identified by using a unique sequence. Each sequence has a good autocorrelation and cross-correlation characteristic, and configuration information corresponding to different first cells may be effectively identified.

In some implementations, the configuration information corresponding to the first cell is determined based on the sequence information of the configuration information corresponding to the first cell. It may be understood that the sequence information of the configuration information corresponding to the first cell is associated with one or more of the following: an identity (identity, ID) of the first cell; load information of the first cell; and a network parameter of the first cell. For example, a terminal device acquires the configuration information by using an anchor cell, where the configuration information is associated with one or more first cells, the first cell is a NES cell, the anchor cell may generate a group of sequences, and a common sequence type may be a Zadoff-Chu sequence, a Gold sequence, or the like. Sequence length and characteristics are selected according to system requirements to ensure sufficient sequence space and reliability. The anchor cell allocates the generated sequence to each first cell, and the allocation may be performed based on the ID of the first cell, the load information of the first cell, or the network parameter of the first cell, so that the sequence information of the configuration information corresponding to each first cell is associated with the ID, the load information, or the network parameter of the first cell. On reception of the configuration information, the terminal device may determine, based on the ID, the load information, or the network parameter of the first cell, the sequence information of the configuration information corresponding to the first cell, and further determine, based on the sequence information of the configuration information corresponding to the first cell, the configuration information corresponding to the first cell.

In some implementations, the ID of the first cell may be understood as an ID capable of uniquely identifying the first cell. For example, the ID of the first cell may be a PCI or another form of identifier.

In some implementations, the sequence information of the configuration information corresponding to the first cell is associated with the ID of the first cell, which may be understood as that a sequence index of the configuration information corresponding to the first cell is associated with the ID of the first cell, that is, the sequence information of the configuration information includes the sequence index, the sequence index of the configuration information corresponding to the first cell is associated with the ID of the first cell, or the ID of the first cell may be mapped to a specific sequence, and a sequence index of the sequence is used as the sequence index of the configuration information corresponding to the first cell. It should be noted that, according to a mapping rule of an ID mapping sequence of the first cell, it should be ensured that IDs of different first cells are mapped to different sequences, and a mapping process should be repeatable to ensure consistency.

In some implementations, the sequence index of the configuration information corresponding to the first cell is determined by using an equation sequence_Index=cell ID mod N+1, where cell ID denotes the ID of the first cell, mod denotes a modulo operation, and N denotes a total quantity of sequences. For example, the terminal device acquires the configuration information by using an anchor cell, where the configuration information is associated with one or more first cells, the first cell is a NES cell, the anchor cell may generate a group of available sequences. It is assumed that N sequences are generated. These sequences may be identified by sequence indices (from 1 to N). A size N of a sequence pool should be large enough to cover the IDs of all possible first cells. The ID of the first cell is mapped to a sequence index in the sequence pool by using an equation sequence_Index=cell ID mod N+1. For another example, for a first cell with an ID of 1003, in a case that N=16, calculation is carried out according to equation 1003 mod 16=11. Therefore, the first cell is allocated to the twelfth sequence in the sequence pool. Each first cell acquires a corresponding sequence from the sequence pool according to the sequence index calculated by the first cell, so as to construct the configuration information and the acquired sequence is used as a sequence of the configuration information corresponding to each first cell. The ID of the first cell is mapped to a sequence index from 1 to N by means of a modulo operation. This method is simple and effective, and is beneficial for evenly allocating a sequence.

In some implementations, the transmission resource of the first request corresponding to the first cell and/or the sequence information of the first request corresponding to the first cell is determined based on the sequence information of the configuration information corresponding to the first cell.

In some implementations, the sequence information of the first request corresponding to the first cell is determined based on the sequence information of the configuration information corresponding to the first cell. It may be understood that the sequence information of the first request corresponding to the first cell is the sequence information of the configuration information corresponding to the first cell. For example, the first cell is a NES cell, and terminal devices camping on different first cells may acquire the sequence information of the configuration information corresponding to the first cell after receiving the configuration information from an anchor cell, and carry the sequence information in the first request, so that the first cell determines the terminal device that transmits the first request based on the sequence information of the received first request, and then distinguishes whether the first request belongs to the first cell.

In some implementations, the transmission resource of the first request corresponding to the first cell includes a physical resource block (PRB), that is, a resource for transmitting the first request corresponding to the first cell includes a PRB.

In some implementations, the PRB index of the first request corresponding to the first cell is determined based on the sequence index of the configuration information corresponding to the first cell and/or the ID of the terminal device, that is, based on the sequence index of the configuration information corresponding to the first cell and/or the ID of the terminal device, the PRB resource for transmitting the first request in the first cell may be determined.

In some implementations, an initial PRB index of the first request corresponding to the first cell is determined by using an equation PRB_Index_{INIT}=(sequence_Index*K)mod M, where sequence_Index denotes the sequence index of the configuration information corresponding to the first cell, K denotes a mapping factor, mod denotes a modulo operation, and M denotes a total length of a PRB for transmitting the first request that is set for the first cell.

It should be noted that a size of the total length M of the PRB for transmitting the first request set for each first cell is the same.

In some implementations, the total length M of the PRB for transmitting the first request is determined based on a maximum PRB length of the first request set for the first cell and/or a quantity of supported terminal devices.

In some implementations, the PRB index of the first request corresponding to the first cell transmitted by an i^{th} terminal device is determined based on the initial PRB index of the first request corresponding to the first cell and an ID of the i^{th} terminal device.

To ensure a one-to-one correspondence between the ID of the terminal device and the PRB index in the PRB pool for transmitting the first request in the first cell, in some implementations, the PRB index of the i^{th} terminal device for transmitting the first request corresponding to the first cell is determined by using an equation PRB_Index(i)=UE_ID(i)mod M+PRB_Index_{INIT}, where UE_ID(i) denotes the ID of the i^{th} terminal device, mod denotes a modulo operation, and PRB_Index_{INIT} denotes an initial PRB index of the first request corresponding to the first cell. It should be noted that UE_ID is a positive integer, and different UE_ID should generate different PRB_Index after mapping by using the foregoing equation to avoid a conflict. In addition, the PRB_Index calculated each time by a same UE_ID is consistent, and the equation can accommodate different quantities of terminal devices and available PRB quantities. Meanwhile, this method can ensure that when M is less than or equal to a quantity of PRB pools, all UE_ID are mapped to different PRB_Index.

In some implementations, the PRB index of the first request corresponding to the first cell transmitted by the i^{th} terminal device is determined through an equation PRB_Index(i)=[a*UE_ID(i)+b]mod M+PRB_Index_{INIT}, where a and b represent pre-configured constants, UE_ID(i) denotes an ID of the i^{th} terminal device, mod denotes a modulo operation, and PRB_Index_{INIT} denotes an initial PRB index of the first request corresponding to the first cell. The pre-configured constants a and b may increase randomness and dispersion of the mapping, which is beneficial for increasing uniformity of the mapping, and prevents some PRB_Index from overcongestion.

In some implementations, a may be a prime number greater than M, which is beneficial for avoiding periodic overlapping.

In some implementations, the PRB index of the first request corresponding to the first cell transmitted by the i^{th} terminal device is determined through an equation PRB_Index(i)=[Hash(UE_ID(i))]mod M+PRB_Index_{INIT}, where Hash(⋅) denotes a hash function, UE_ID(i) denotes an ID of the i^{th} terminal device, mod denotes a modulo operation, and PRB_Index_{INIT} denotes an initial PRB index of the first request corresponding to the first cell. By using the hash function, it may be ensured that the mapping is highly distributed. Even if the UE_IDs are very close, the PRB_Indices to which UE_IDs are mapped may be completely different, which is beneficial for coping with a situation in which UE_IDs are relatively dense, so as to adapt to a more complex network environment.

Embodiment 1 and Embodiment 2 above respectively introduce the related solution in which the first information is used to determine whether the first cell supports the target SIB1, and the related solution in which the first information is used to determine the transmission resource of the first request and/or the sequence information of the first request. In some scenarios, Embodiment 1 and Embodiment 2 may be used separately. In some other scenarios, Embodiment 1 and Embodiment 2 may be used in combination.

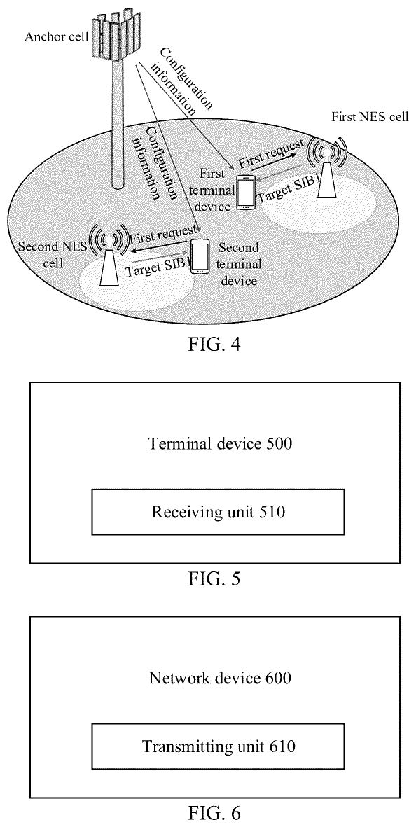

In order to facilitate understanding, the solution of combining Embodiment 1 with Embodiment 2 will be introduced with reference to FIG. 4.

It is assumed that the first information is used to determine whether the first cell supports the target SIB1, the transmission resource of the first request, and the sequence information of the first request. The first information includes the configuration information, and the configuration information is associated with PCIs of two first cells. Referring to FIG. 4, the two first cells are a first NES cell and a second NES cell respectively. A terminal device that camps on the first NES cell is a first terminal device, and a terminal device that camps on the second NES cell is a second terminal device.

Still referring to FIG. 4, the anchor cell sends the configuration information to the terminal devices camping on the first NES cell and the second NES cell. After receiving the configuration information, the first terminal device camping on the first NES cell and the second terminal device camping on the second NES cell determine, based on the PCI of the cell acquired from the SSB of the respective cell thereof, that the first NES cell and the second NES cell support the transmission of the target SIB1. In addition, the first terminal device and the second terminal device determine, based on the IDs of the first NES cell and the ID of the second NES cell, the sequence information of the configuration information respectively corresponding to the first terminal device and the second terminal device, and determine, based on the sequence information of the configuration information respectively corresponding to the first NES cell, the transmission resources and the sequence information of the first request corresponding to the first NES cell and the first request corresponding to the second NES cell. Finally, the first terminal device and the second terminal device separately transmit the first request to the first NES cell and the second NES cell based on the transmission resources and the sequence information of the first request that are respectively determined by the first terminal device and the second terminal device. The first NES cell and the second NES cell receive the first request, and determine, based on the sequence information of the first request, whether the first request is the first request corresponding to the terminal device. In a case that the first NES cell and the second NES cell determine that the first requests are the first requests respectively corresponding to the first NES cell and the second NES cell, the first NES cell and the second NES cell separately transmit the target SIB1 to the first terminal device and the second terminal device.

The method embodiments of the present application are described in detail above with reference to FIG. 1 to FIG. 4. Apparatus embodiments of the present application are described in detail below with reference to FIG. 5 to FIG. 7. It should be understood that the description of the method embodiments corresponds to the description of the apparatus embodiments, and therefore, for a part that is not described in detail, reference may be made to the foregoing method embodiments.

FIG. 5 is a schematic diagram of a terminal device according to an embodiment of the present application. The terminal device 500 includes a receiving unit 510.

The receiving unit 510 is configured to receive first information transmitted by a network device, where the first information is used for one or more of the following: determining whether a first cell supports transmission of a target system information block SIB1, where the transmission of the target SIB1 is triggered based on a request of the terminal device; determining a transmission resource of the first request, where the first request is used for requesting the target SIB1 of the first cell; or determining sequence information of the first request.

In some implementations, in a case that the first information is used to determine whether the first cell supports the transmission of the target SIB1, the first information includes one or more of the following: a first parameter, where the first parameter is carried in a master information block MIB of the first cell; or configuration information, where the configuration information is used to configure the first request.

In some implementations, the first parameter is used to indicate a frequency domain offset between a transmission resource of a synchronization signal broadcast channel block SSB and a reference resource.

In some implementations, the configuration information is received by the terminal device in an anchor cell and/or the first cell, and the configuration information is associated with one or more of the first cells.

In some implementations, that the configuration information is associated with one or more of the first cells includes: the configuration information is associated with one or more of the following: physical cell identifier PCI of one or more of the first cells; or frequency information of one or more of the first cells.

In some implementations, a transmitting mode of the configuration information includes one or more of the following manners: being periodically broadcast; being carried in downlink control information DCI; being carried in a physical downlink shared channel PDSCH; and being carried in a SIB.

In some other implementations, after the terminal device receives the configuration information, the terminal device further includes: the receiving unit 510, further configured to receive first indication information transmitted by the network device, where the first indication information is used to indicate update of the configuration information.

In some implementations, in a case that the first cell supports transmission of the target SIB1, a SSB in the first cell is a non-cell defining SSB.

In some implementations, in a case that the terminal device does not support triggering the SIB1 based on the request of the terminal device, the terminal device further includes: the receiving unit 510, further configured to receive second information transmitted by the network device, where the second information is used to determine a search space of a cell-defining SSB transmitted in the first cell, and the second information is carried in a MIB of the non-cell defining SSB.

In some implementations, in a case that the terminal device supports triggering the SIB1 based on the request of the terminal device, and the SSB of the first cell received by the terminal device is a non-cell defining SSB, the terminal device further includes: a determining unit, configured to determine whether the first cell supports transmission of the target SIB1 based on the first parameter and/or the configuration information.

In some implementations, in a case that the first information is used to determine the transmission resource of the first request and/or the sequence information of the first request, the first information includes configuration information for configuring the first request.

In some implementations, the configuration information is associated with one or more first cells, and configuration information corresponding to the first cell is determined based on one or more of the following: a transmission resource of the configuration information corresponding to the first cell; or sequence information of the configuration information corresponding to the first cell.

In some implementations, the sequence information of the configuration information corresponding to the first cell is associated with one or more of the following: an identity ID of the first cell; load information of the first cell; or a network parameter of the first cell.

In some implementations, that the sequence information of the configuration information corresponding to the first cell is associated with the ID of the first cell includes: the sequence information of the configuration information includes a sequence index, and the sequence index of the configuration information corresponding to the first cell is determined through an equation sequence_Index=cell ID mod N+1, where cell ID denotes the ID of the first cell, mod denotes a modulo operation, and N denotes a total quantity of sequences.

In some implementations, the transmission resource of the first request corresponding to the first cell and/or the sequence information of the first request corresponding to the first cell is determined based on the sequence information of the configuration information corresponding to the first cell.

In some implementations, the sequence information of the first request corresponding to the first cell is the sequence information of the configuration information corresponding to the first cell.

In some implementations, the transmission resource of the first request corresponding to the first cell includes a physical resource block PRB, and a PRB index of the first request corresponding to the first cell is determined based on a sequence index of the configuration information and/or an ID of the terminal device.

In some implementations, an initial PRB index of the first request corresponding to the first cell is determined by using an equation PRB_Index_{INIT}=(sequence_Index*K)mod M, where sequence_Index denotes the sequence index of the configuration information corresponding to the first cell, K denotes a mapping factor, mod denotes a modulo operation, and M denotes a total length of a PRB for transmitting the first request that is set for the first cell.

In some implementations, the PRB index of the first request corresponding to the first cell transmitted by an i^{th} terminal device is determined based on the initial PRB index of the first request corresponding to the first cell and an ID of the i^{th} terminal device.

In some implementations, the PRB index of the first request corresponding to the first cell transmitted by the i^{th} terminal device is determined through an equation PRB_Index(i)=UE_ID(i)mod M+PRB_Index_{INIT}, where UE_ID(i) denotes an ID of the i^{th} terminal device, mod denotes a modulo operation, and PRB_Index_{INIT} denotes an initial PRB index of the first request corresponding to the first cell.

In some implementations, the PRB index of the first request corresponding to the first cell transmitted by the i^{th} terminal device is determined through an equation PRB_Index(i)=[a*UE_ID(i)+b]mod M+PRB_Index_{INIT}, where a and b represent pre-configured constants, UE_ID(i) denotes an ID of the i^{th} terminal device, mod denotes a modulo operation, and PRB_Index_{INIT} denotes an initial PRB index of the first request corresponding to the first cell.

In some implementations, the PRB index of the first request corresponding to the first cell transmitted by the i^{th} terminal device is determined through an equation PRB_Index(i)=[Hash(UE_ID(i))]mod M+PRB_Index_{INIT}, where Hash(⋅) denotes a hash function, UE_ID(i) denotes an ID of the i^{th} terminal device, mod denotes a modulo operation, and PRB_Index_{INIT} denotes an initial PRB index of the first request corresponding to the first cell.

FIG. 6 is a schematic diagram of a network device according to an embodiment of the present application. The network device 600 includes a transmitting unit 610.

The transmitting unit 610 is configured to transmit first information to a terminal device, where the first information is used for one or more of the following: determining whether a first cell supports transmission of a target system information block SIB1, where the transmission of the target SIB1 is triggered based on a request of the terminal device; determining a transmission resource of the first request, where the first request is used to request the target SIB1 of the first cell; or determining sequence information of the first request.

In some implementations, in a case that the first information is used to determine whether the first cell supports the transmission of the target SIB1, the first information includes one or more of the following: a first parameter, where the first parameter is carried in a master information block MIB of the first cell; or configuration information, where the configuration information is used to configure the first request.

In some implementations, the first parameter is used to indicate a frequency domain offset between a transmission resource of a synchronization signal broadcast channel block SSB and a reference resource.

In some implementations, the configuration information is received by the terminal device in an anchor cell and/or the first cell, and the configuration information is associated with one or more of the first cells.

In some implementations, that the configuration information is associated with one or more of the first cells includes: the configuration information is associated with one or more of the following: physical cell identifier PCI of one or more of the first cells; or frequency information of one or more of the first cells.

In some implementations, a transmitting mode of the configuration information includes one or more of the following manners: being periodically broadcast; being carried in downlink control information DCI; being carried in a physical downlink shared channel PDSCH; and being carried in a SIB.

In some other implementations, after the network device sends the configuration information, the network device further includes: the transmitting unit 610 is further configured to transmit first indication information to the terminal device, where the first indication information is used to indicate update of the configuration information.

In some implementations, in a case that the first cell supports transmission of the target SIB1, a SSB in the first cell is a non-cell defining SSB.

In some implementations, in a case that the terminal device does not support triggering the SIB1 based on the request of the terminal device, the network device further includes: the transmitting unit 610 is further configured to transmit second information to the terminal device, where the second information is used to determine a search space of a cell-defining SSB transmitted in the first cell, and the second information is carried in a MIB of the non-cell defining SSB.

In some implementations, in a case that the first information is used to determine the transmission resource of the first request and/or the sequence information of the first request, the first information includes configuration information for configuring the first request.

In some implementations, the configuration information is associated with one or more first cells, and configuration information corresponding to the first cell is determined based on one or more of the following: a transmission resource of the configuration information corresponding to the first cell; or sequence information of the configuration information corresponding to the first cell.

In some implementations, the sequence information of the configuration information corresponding to the first cell is associated with one or more of the following: an identity ID of the first cell; load information of the first cell; or a network parameter of the first cell.

In some implementations, that the sequence information of the configuration information corresponding to the first cell is associated with the ID of the first cell includes: the sequence information of the configuration information includes a sequence index, and the sequence index of the configuration information corresponding to the first cell is determined through an equation sequence_Index=cell ID mod N+1, where cell ID denotes the ID of the first cell, mod denotes a modulo operation, and N denotes a total quantity of sequences.

In some implementations, the transmission resource of the first request corresponding to the first cell and/or the sequence information of the first request corresponding to the first cell is determined based on the sequence information of the configuration information corresponding to the first cell.

In some implementations, the sequence information of the first request corresponding to the first cell is the sequence information of the configuration information corresponding to the first cell.

In some implementations, the transmission resource of the first request corresponding to the first cell includes a physical resource block PRB, and a PRB index of the first request corresponding to the first cell is determined based on a sequence index of the configuration information and/or an ID of the terminal device.

In some implementations, an initial PRB index of the first request corresponding to the first cell is determined through an equation PRB_Index_{INIT}=(sequence_Index*K)mod M, where sequence_Index denotes the sequence index of the configuration information corresponding to the first cell, K denotes a mapping factor, mod denotes a modulo operation, and M denotes a total length of a PRB for transmitting the first request that is set for the first cell.

In some implementations, the PRB index of the first request corresponding to the first cell transmitted by an i^{th} terminal device is determined based on the initial PRB index of the first request corresponding to the first cell and an ID of the i^{th} terminal device.

In some implementations, the PRB index of the first request corresponding to the first cell transmitted by the i^{th} terminal device is determined through an equation PRB_Index(i)=UE_ID(i)mod M+PRB_Index INIT, where UE_ID(i) denotes an ID of the i^{th} terminal device, mod denotes a modulo operation, and PPRB_Index_{INIT} denotes an initial PRB index of the first request corresponding to the first cell.

In some implementations, the PRB index of the first request corresponding to the first cell transmitted by the i^{th} terminal device is determined through an equation PRB_Index(i)=[a*UE_ID(i)+b]mod M+PRB_Index_{INIT}, where a and b represent pre-configured constants, UE_ID(i) denotes an ID of the i^{th} terminal device, mod denotes a modulo operation, and PRB_Index_{INIT} denotes an initial PRB index of the first request corresponding to the first cell.

In some implementations, the PRB index of the first request corresponding to the first cell transmitted by the i^{th} terminal device is determined through an equation PRB_Index(i)=[Hash(UE_ID(i))]mod M+PRB_Index_{INIT}, where Hash(⋅) denotes a hash function, UE_ID(i) denotes an ID of the i^{th} terminal device, mod denotes a modulo operation, and PRB_Index_{INIT} denotes an initial PRB index of the first request corresponding to the first cell.

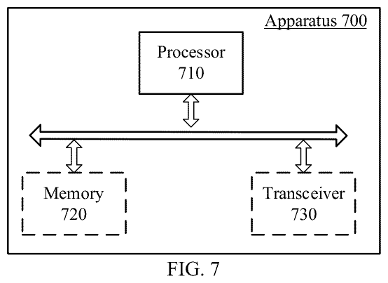

In an optional embodiment, the receiving unit 510 may be a transceiver 730. The terminal device 500 may further include a processor 710 and a memory 720, as shown in FIG. 7.

In an optional embodiment, the transmitting unit 610 may be a transceiver 730. The network device 600 may further include a processor 710 and a memory 720, as shown in FIG. 7.

FIG. 7 is a schematic structural diagram of a communications apparatus according to an embodiment of the present application. Dashed lines in FIG. 7 indicate that a unit or module is optional. The apparatus 700 may be configured to implement the methods described in the foregoing method embodiments. The apparatus 700 may be a chip, a terminal device, or a network device.

The apparatus 700 may include one or more processors 710. The processor 710 may support the apparatus 700 in implementing the methods described in the foregoing method embodiments. The processor 710 may be a general-purpose processor or a dedicated processor. For example, the processor may be a central processing unit (central processing unit, CPU). Alternatively, the processor may be another general-purpose processor, a digital signal processor (digital signal processor, DSP), an application-specific integrated circuit (application specific integrated circuit, ASIC), a field-programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 700 may further include one or more memories 720. The memory 720 stores a program, and the program may be executed by the processor 710, so that the processor 710 performs a method described in the foregoing method embodiments. The memory 720 may be separate from the processor 710 or may be integrated into the processor 710.

The apparatus 700 may further include a transceiver 730. The processor 710 may communicate with another device or chip by using the transceiver 730. For example, the processor 710 may transmit data to and receive data from another device or chip by using the transceiver 730.

An embodiment of the present application further provides a computer-readable storage medium for storing a program. The computer-readable storage medium may be applied to the terminal or the network device provided in embodiments of the present application, and the program causes a computer to execute the methods performed by the terminal or the network device in various embodiments of the present application.

An embodiment of the present application further provides a computer program product. The computer program product includes a program. The computer program product may be applied to the terminal or the network device provided in embodiments of the present application, and the program causes a computer to execute the methods performed by the terminal or the network device in various embodiments of the present application.

An embodiment of the present application further provides a computer program. The computer program may be applied to a terminal or a network device provided in embodiments of the present application, and the computer program causes a computer to execute the methods performed by the terminal or the network device in various embodiments of the present application.

It should be understood that the terms “system” and “network” in the present application may be used interchangeably. In addition, the terms used in the present application are merely used to explain the specific embodiments of the present application, and are not intended to limit the present application. In the specification, claims, and accompanying drawings of the present application, the terms “first”, “second”, “third”, “fourth”, and so on are intended to distinguish between different objects but do not describe a particular order. In addition, the terms “include” and “have” and any variations thereof are intended to cover a non-exclusive inclusion.

In embodiments of the present application, “indicate” mentioned herein may be a direct indication, or may be an indirect indication, or may mean that there is an association relationship. For example, A indicates B, which may mean that A directly indicates B, for example, B may be obtained by using A; or may mean that A indirectly indicates B, for example, A indicates C, and B may be obtained by using C; or may mean that there is an association relationship between A and B.

In embodiments of the present application, the term “correspond” may mean that there is a direct or indirect correspondence between the two, or may mean that there is an association relationship between the two, or may mean that there is a relationship such as indicating and being indicated, or configuring and being configured.

In embodiments of the present application, “predefined” or “pre-configured” may be implemented by pre-storing corresponding code, tables, or other forms that may be used to indicate related information in devices (for example, including a terminal device and a network device), and a specific implementation thereof is not limited in the present application. For example, being pre-defined may refer to being defined in a protocol.

In embodiments of the present application, the “protocol” may refer to a standard protocol in the communications field, and may include, for example, an LTE protocol, an NR protocol, and a related protocol applied to a future communications system, which is not limited in the present application.

In embodiments of the present application, the term “and/or” is merely an association relationship that describes associated objects, and denotes that there may be three relationships. For example, A and/or B may represent three cases: only A exists, both A and B exist, and only B exists. In addition, the character “/” in this specification generally indicates an “or” relationship between the associated objects.

In embodiments of the present application, sequence numbers of the foregoing processes do not mean execution sequences. The execution sequences of the processes should be determined according to functions and internal logic of the processes, and should not be construed as any limitation on the implementation processes of embodiments of the present application.

In several embodiments provided in the present application, it should be understood that, the disclosed system, apparatus, and method may be implemented in other manners. For example, the foregoing described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. Indirect couplings or communication connections between apparatuses or units may be implemented in electrical, mechanical, or other forms.

The units described as separate parts may be or may not be physically separate, and parts displayed as units may be or may not be physical units, and may be at one location, or may be distributed on a plurality of network elements. Some or all of the units may be selected according to actual requirements to achieve the objectives of the solutions of embodiments.

In addition, functional units in embodiments of the present application may be integrated into one processing unit, or each of the units may exist alone physically, or two or more units may be integrated into one unit.

All or some of the foregoing embodiments may be implemented by using software, hardware, firmware, or any combination thereof. When the software is used to implement embodiments, all or some of embodiments may be implemented in a form of a computer program product. The computer program product includes one or more computer instructions. When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (such as a coaxial cable, an optical fiber, and a digital subscriber line (digital subscriber line, DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (digital video disc, DVD)), a semiconductor medium (for example, a solid state drive (solid state drive, SSD)), or the like.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A wireless communication method, comprising:
receiving, by a terminal device, first information from a network device; and
transmitting, by the terminal device to the network device, a first request based on the first information, wherein the first information is used to determine at least one of the following:
whether a first cell supports transmission of a target system information block 1 (SIB1), wherein the target SIB1 is triggered based on the first request;
a transmission resource of the first request, wherein the first request is used to request the target SIB1 of the first cell; or
sequence information of the first request.

2. The method according to claim 1, wherein in a case that the first information is used to determine whether the first cell supports the transmission of the target SIB1, the first information comprises one or more of the following:
a first parameter that is carried in a master information block (MIB) of the first cell; or
configuration information that configures the first request.

3. The method according to claim 2, wherein the first parameter indicates a frequency domain offset between a transmission resource of a synchronization signal broadcast channel block (SSB) and a reference resource.

4. The method according to claim 2, wherein the configuration information is received by the terminal device in at least one of an anchor cell or the first cell, wherein the configuration information is associated with one or more of the following:
physical cell identifier (PCI) of the first cell; or
frequency information of the first cell.

5. The method according to claim 2, wherein a transmitting mode of the configuration information comprises one or more of the following:
being periodically broadcast;
being carried in downlink control information (DCI);
being carried in a physical downlink shared channel (PDSCH); or
being carried in a SIB.

6. The method according to claim 2, wherein after the terminal device receives the configuration information, the method further comprises:
receiving, by the terminal device, first indication information from the network device, wherein the first indication information indicates update of the configuration information.

7. The method according to claim 2, wherein in a case that the first cell supports transmission of the target SIB1, a SSB in the first cell is a non-cell defining SSB.

8. The method according to claim 7, wherein in a case that the terminal device does not support triggering the SIB1 based on the first request of the terminal device, the method further comprises:
receiving, by the terminal device, second information from the network device, wherein the second information is used to determine a search space of a cell-defining SSB received in the first cell, and the second information is carried in a MIB of the non-cell defining SSB.

9. The method according to claim 7, wherein in a case that the terminal device supports triggering the SIB1 based on the first request of the terminal device, and the SSB of the first cell received by the terminal device is a non-cell defining SSB, the method further comprises:
determining, by the terminal device based on at least one of the first parameter or the configuration information, whether the first cell supports transmission of the target SIB1.

10. The method according to claim 1, wherein in a case that the first information is used to determine at least one of the transmission resource of the first request or the sequence information of the first request, the first information comprises configuration information for configuring the first request, wherein the configuration information is associated with the first cell, and configuration information corresponding to the first cell is determined based on one or more of the following:
a transmission resource of the configuration information corresponding to the first cell; or
sequence information of the configuration information corresponding to the first cell.

11. The method according to claim 10, wherein the sequence information of the configuration information corresponding to the first cell is associated with one or more of the following:
an identity (ID) of the first cell;
load information of the first cell; or
a network parameter of the first cell.

12. The method according to claim 11, wherein the sequence information of the configuration information corresponding to the first cell is associated with the ID of the first cell, and wherein:
the sequence information of the configuration information comprises a sequence index, and the sequence index of the configuration information corresponding to the first cell is determined through an equation sequence_{Index}=cell ID mod N+1,
wherein cell ID denotes the ID of the first cell, mod denotes a modulo operation, and N denotes a total quantity of sequences.

13. The method according to claim 10, wherein at least one of a transmission resource of a first request corresponding to the first cell or sequence information of the first request corresponding to the first cell is determined based on the sequence information of the configuration information corresponding to the first cell.

14. The method according to claim 13, wherein the sequence information of the first request corresponding to the first cell is the sequence information of the configuration information corresponding to the first cell.

15. The method according to claim 13, wherein the transmission resource of the first request corresponding to the first cell comprises a physical resource block (PRB), and a PRB index of the first request corresponding to the first cell is determined based on at least one of a sequence index of the configuration information or an ID of the terminal device.

16. The method according to claim 15, wherein an initial PRB index of the first request corresponding to the first cell is determined through an equation PRB_{Index}_{_{INIT}}=(sequence_{Index}*K)mod M,
wherein, sequence_{Index} denotes the sequence index of the configuration information corresponding to the first cell, K denotes a mapping factor, mod denotes a modulo operation, and M denotes a total length of a PRB for transmitting the first request that is set for the first cell.

17. The method according to claim 16, wherein the PRB index of the first request corresponding to the first cell transmitted by an i^{th} terminal device is determined based on the initial PRB index of the first request corresponding to the first cell and an ID of the i^{th} terminal device.

18. The method according to claim 17, wherein the PRB index of the first request corresponding to the first cell transmitted by the i^{th} terminal device is determined through an equation PRB_{Index(i)}=UE_{ID(i)}mod M+PRB_{Index}_{_{INIT}},
wherein UE_{ID(i)} denotes an ID of the i^{th} terminal device, mod denotes a modulo operation, and PRB_{Index}_{_{INIT}} denotes an initial PRB index of the first request corresponding to the first cell.

19. The method according to claim 17, wherein the PRB index of the first request corresponding to the first cell transmitted by the i^{th} terminal device is determined through at least one of
$$a first equation {PRB}_{Index ( i )} = [ a * {UE}_{ID ( i )} + b ] mod M + {PRB}_{{Index}_{INIT}} , or$$
$$a second equation {PRB}_{Index ( i )} = [ Hash ( {UE}_{ID ( i )} ) ] mod M + {PRB}_{{Index}_{INIT}} ;$$
wherein a and b represent pre-configured constants, UE_{ID(i)} denotes an ID of the i^{th} terminal device, mod denotes a modulo operation, and PRB_{Index}_{_{INIT}} denotes an initial PRB index of the first request corresponding to the first cell, Hash(⋅) denotes a hash function.

20. A wireless communication method, comprising:
transmitting, by a network device to a terminal device, first information from the network device; and
receiving, by the network device from the terminal device, a first request based on the first information, wherein the first information indicates at least one of the following:
whether a first cell supports transmission of a target system information block 1 (SIB1), wherein the target SIB1 is triggered based on the first request;
a transmission resource of the first request, wherein the first request is used to request the target SIB1 of the first cell; or
sequence information of the first request.
